(19) United States
(12) Patent Application Publication
(10) Pub. No.: US 2005/0024884 A1
(43) Pub. Date: Feb. 3, 2005

(54) Illuminated personal safety device for use by cyclists and joggers

(76) Inventors: Dominick M. Seminara, Boca Raton, FL (US); Michael M. Anthony, Coral Springs, FL (US)

Correspondence Address: Mark D. Bowen;Stearns Weaver Miller, et al., Suite 1900, 200 East Broward Boulevard, Fort Lauderdale, FL, 33301, US

(21) Appl. No.: 10/630,085

(22) Filed: Jul. 30, 2003

(51) Int. Cl. B62J 6/00

(52) U.S. Cl. 362/473

(57) ABSTRACT

An illuminated safety device adapted for attachment to a bicycle or scooter, or worn by a jogger at night is disclosed. The safety device includes a pair of pivotally connected illuminated panels configurable between a compact stored configuration wherein the panels are disposed in substantially adjacent overlapping relation to a deployed configuration wherein the panels form a generally rectangular display. In the deployed configuration light-emitting devices such as LED'S, function to provide an illuminated display and illuminated signaling, including an illuminated word, such as “BIKE” or “JOGGER”, along with left and right blinker lights automatically actuated by a tilt switch. Accordingly, when the biker or jogger leans to turn left: or right, the corresponding left or right blinker is activated. In the stored configuration the electrical contact terminals disengage from the electrical contact with the battery power source, and the display surfaces are protected as the opposing display panels are pivotally folded in overlapping face-to-face relation.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

1. Field of the Invention

The present invention relates to illumination devices, and more particularly to illuminated personal safety devices for use by those exercising or recreating outdoors, primarily joggers and bicyclists.

2. Description of Related Art

Millions of people exercise by bicycling and jogging in the United States, and worldwide. In fact, it is estimated that there are over 20 million bicycles in the United States alone. Bicycles and foot scooters serve as a means for transportation, as well as enjoyment, particularly for young children. A recent survey indicates that approximately ten thousand children are injured every day for various reasons. Some of these injuries are related to accidents involving bicycles and foot scooters. Serious injury, or even death, can result when a child riding a bicycle or foot scooter is struck by a car.

Bicycle accidents occur with a high degree of frequency particularly at night, for bicycle riders often share the same roads with vehicular traffic. A bicycle is a relatively small vehicle that in terms of visible structure is virtually two-dimensional; for its transverse dimension is defined only by the handlebars. Hence, it is normally quite difficult for car drivers to see and avoid bicyclists. It is for this reason that all bicycles are equipped at their rear with prism-type reflectors that alert a driver at night of the presence of the bicycle when the headlights are shown onto the reflector. The problem with a prism-type reflector is two-fold; for not only is its normal placement below the seat of the bicycle and therefore not easily discernible to a driver of a vehicle behind the bicyclist, but it is not optically activated unless the headlight beam of the vehicle directly strikes the reflector. Thus, a prism-type reflector on a bicycle is often not seen by car drivers.

The drawbacks associated with the use of reflectors has been known for quite some time, thus lights have been incorporated into some bicycles. These lights are typically mounted either onto the handlebars or rear seat post of the bicycle. Typically, such lights are attached using mounting assemblies, screws, and complex clamps so that the light becomes a nearly permanent fixture to the bicycle. Another disadvantage of such lights is that unless lights are attached to all four sides of the bicycle, a driver approaching the bicycle may not be able to view the light. For example, a light attached to the seat post and directed towards the rear of the bicycle will enable drivers approaching from the rear to easily see the bicycle within a certain distance. However, a driver approaching from the front of the bicycle will be unable to see the rearwardly directed light. Yet another problem with such lights is that they are typically comprised of an incandescent lamp that requires a significant amount of power and is subject to breakage due to the shocks and jolts experienced during the riding of the bicycle. Thus, these lamps must be periodically replaced. The normal life span of such lights is also fairly limited, even absent such shocks and jolts.

Foot scooters, which are typically smaller than bicycles, have traditionally been devoid of such reflectors and lights, increasing the risk of injury, particularly at night.

Joggers are also typically devoid of reflectors and lights, and mostly rely on light colored clothing to provide an indication of their presence.

The prior art reveals a number of safety light devices that identify a biker or jogger by means of reflectors and/or illumination. Among the prior art references that the present applicant is aware of are the following. U.S. Pat. No. 4,204,191, issued to Daniels, discloses a lighting system for bicycles that includes a flasher switch and an illumination network including an oscillator circuit. U.S. Pat. No. 4,423,473, issued to Kirkley, discloses a safety light worn by joggers and cyclists that provides intermittent illumination. U.S. Pat. No. 4,523,258, issued to Morse, discloses a flexible safety belt worn by a jogger. The device includes oscillating lights so that the jogger is visible from virtually any angle. U.S. Pat. No. 4,709,307, issued to Branom, discloses an illuminated article of clothing with light emitting diodes arranged in a pattern thereon. U.S. Pat. No. 4,849,863, issued to Gallegos, discloses a belt for joggers and cyclists adapted with a forwardly shining light. U.S. Pat. No. 4,860,177, issued to Simms, discloses a bicycle safety light having constantly moving light emitting diodes. U.S. Pat. No. 5,690,411, issued to Jackman, discloses a wearable signaling system to be worn on the user's person. U.S. Pat. No. 5,070,436, issued to Alexander et al., discloses a signal vest with reflective and lighted elements. U.S. Pat. No. 5,504,662, issued to Huang, discloses a bicycle saddle adapted with a flashing light device triggered by a switch disposed in the saddle. U.S. Pat. No. 5,617,303, issued to Izzo, Sr., discloses a turn signal and horn assembly for a bicycle having manually actuated blinker lights.

The prior art fails to disclose an effective illuminated safety light for use by cyclists and/or joggers that incorporates an illuminated safety display and tilt switch actuated blinker lights. Accordingly, there is a need for a safety light that can be mounted onto a bicycle or scooter and/or worn on the person to provide an illuminated signal indicating the presence of the person at night. The safety light should be resistant to breakage, have a long life, and consume very little power. The present invention fulfills these needs and provides' other related advantages.

### BRIEF SUMMARY OF THE INVENTION

The present invention overcomes the limitations and disadvantages present in the art by providing a battery powered illuminated safety device adapted for attachment to a bicycle or scooter, or worn by a jogger at night. The safety device includes a pair of pivotally connected illuminated panels configurable between a compact stored configuration wherein the panels are disposed in substantially adjacent overlapping relation to a deployed configuration wherein the panels form a generally rectangular display. In the deployed configuration light-emitting devices, such as LED'S, function to provide an illuminated display and illuminated signaling, including an illuminated word, such as “BIKE” or “JOGGER”, along with left and right blinker lights automatically actuated by a tilt switch. Accordingly, when the biker or jogger leans to turn left or right, the corresponding left or right blinker is activated. In the stored configuration the electrical contact terminals disengage from the electrical contact with the battery power source, and the display surfaces are protected as the opposing display panels are pivotally folded in overlapping face-to-face relation.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a perspective view depicting a preferred embodiment of an illuminated safety device attached to a bicycle in a stored configuration;

FIG. 2 is a perspective view depicting the device in a deployed configuration;

FIG. 3 is a front perspective view of the device in the deployed configuration;

FIG. 4 is a rear perspective view thereof;

FIG. 5 is a front exploded perspective view thereof depicting the battery power source;

FIGS. 6 and 7 are front perspective views thereof with the display surface removed;

FIG. 8 is a front view of an alternate embodiment incorporating left and right side illuminating elements with the display surface removed;

FIG. 9 is another alternate embodiment thereof wherein the word “BIKE” is formed by a plurality of light emitting devices;

FIGS. 10-12 illustrate use of the embodiment depicted in FIG. 9 in connection with a bicycle;

FIGS. 13 and 14 illustrate another alternate embodiment thereof adapted to be worn by a jogger;

FIGS. 15 and 16 depict an alternate embodiment thereof;

FIG. 17 depicts an alternate embodiment adapted to be worn by a bicyclist;

FIGS. 18A and 18B depict panels adapted to display the word “Jogger” when used with the present invention; and

FIGS. 19A and 19B depict panels adapted to display the word “Biker” when used with the present invention.

### DETAILED DESCRIPTION OF THE INVENTION

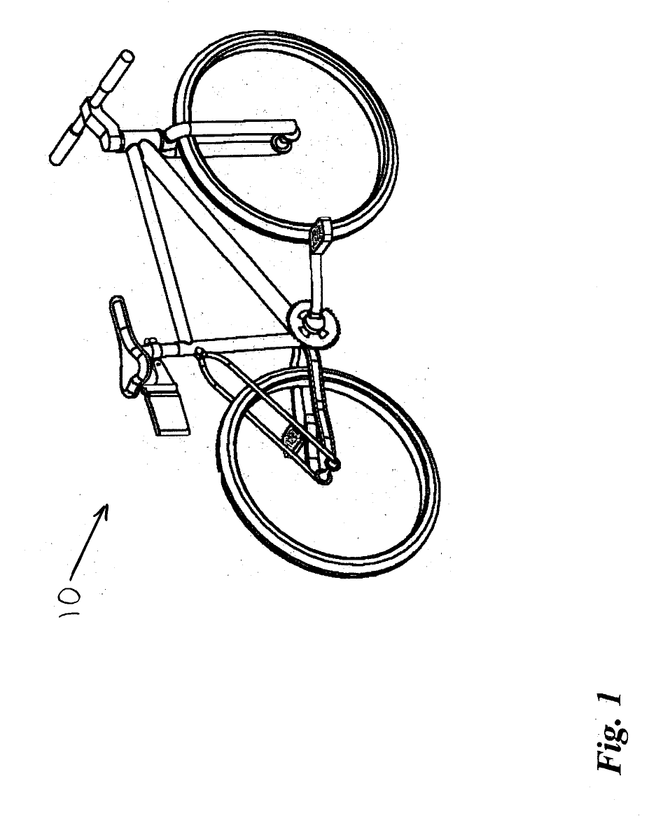

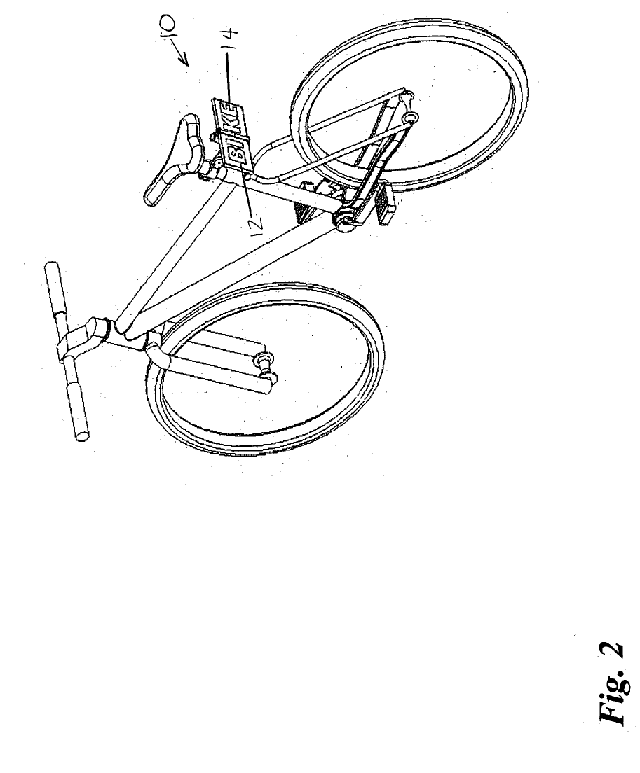

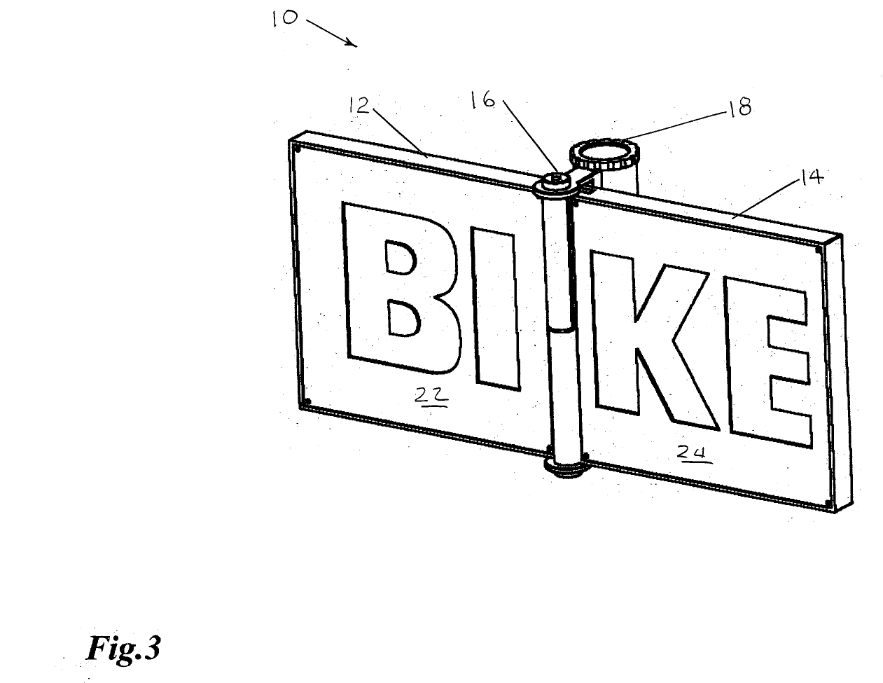

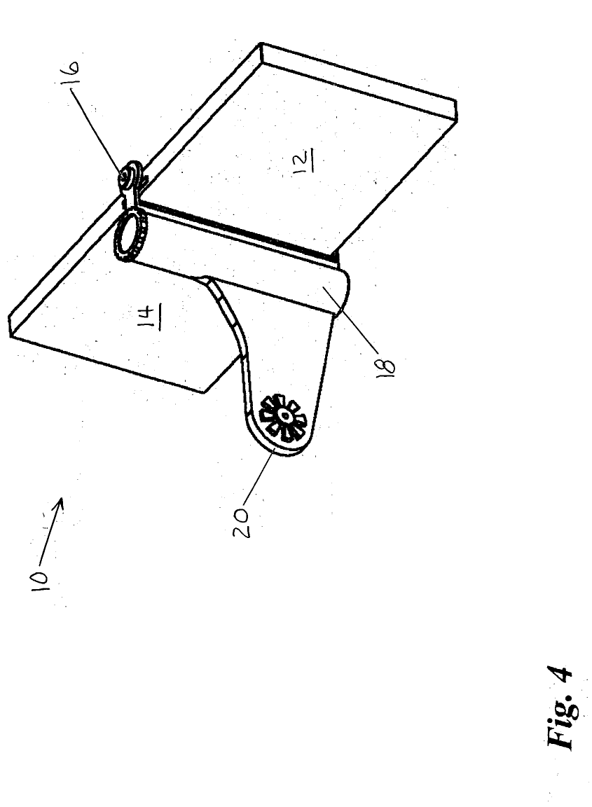

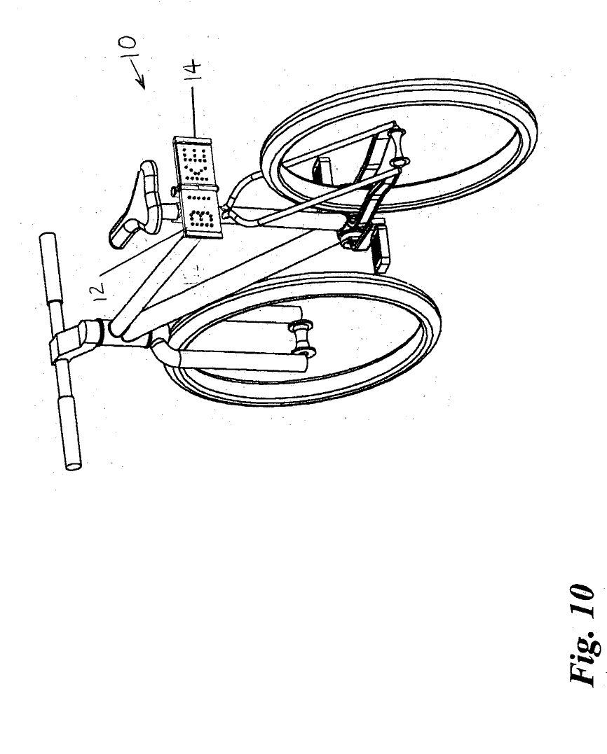

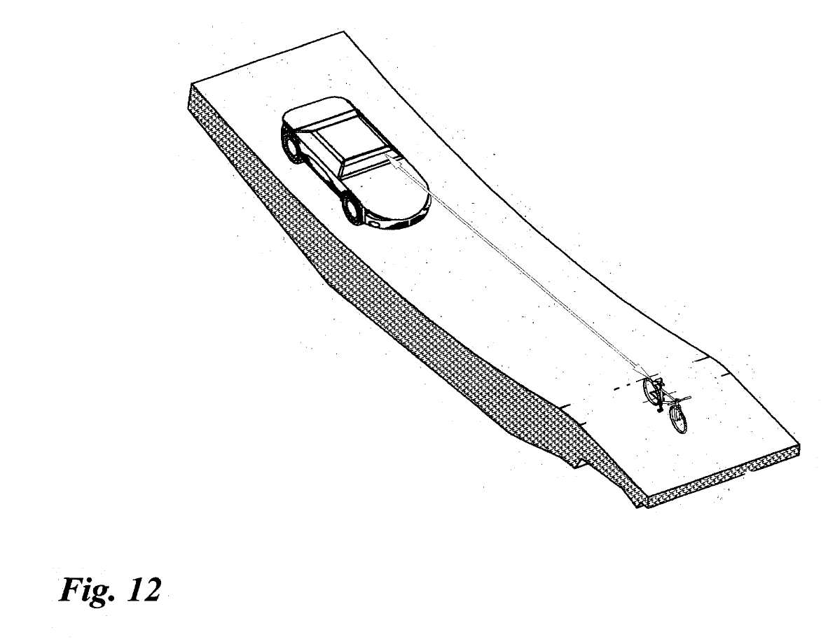

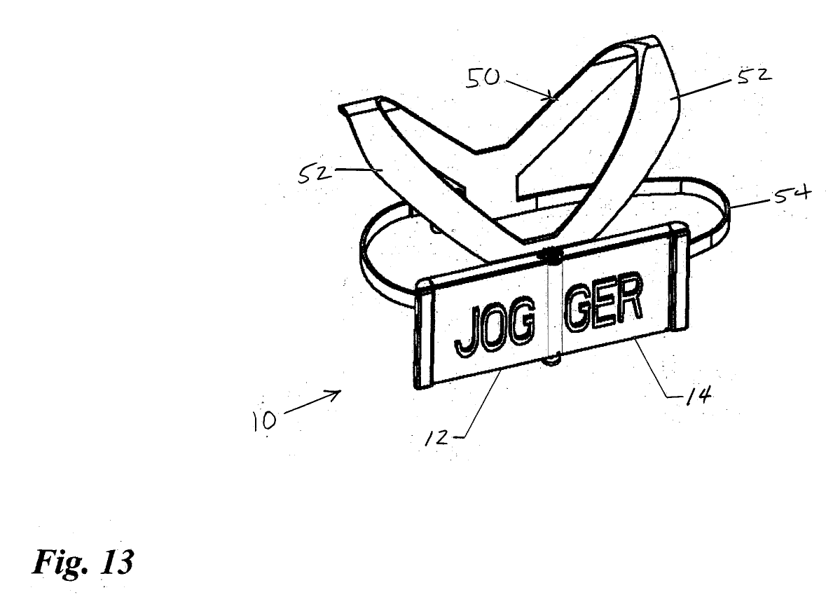

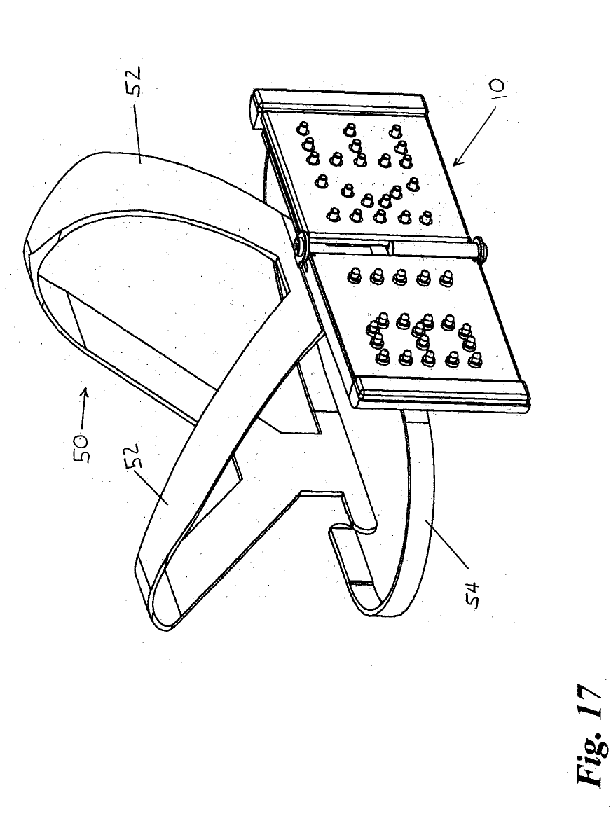

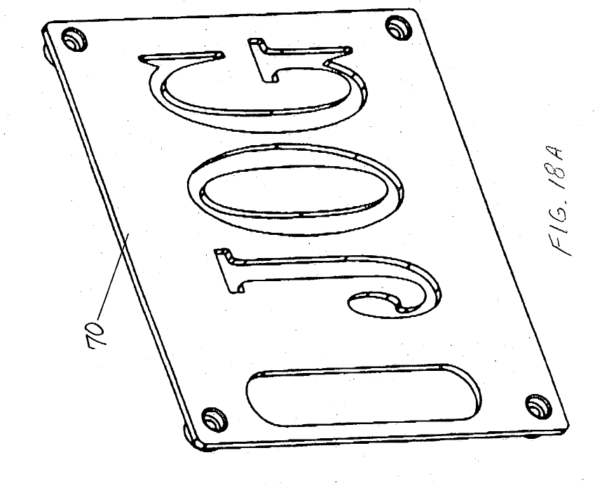

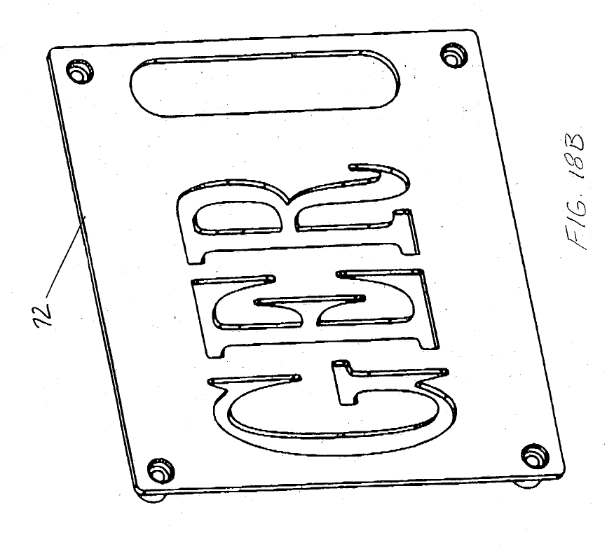

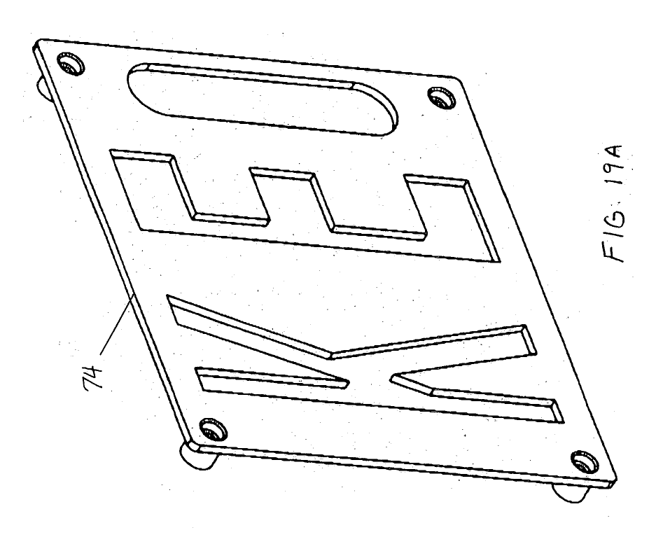

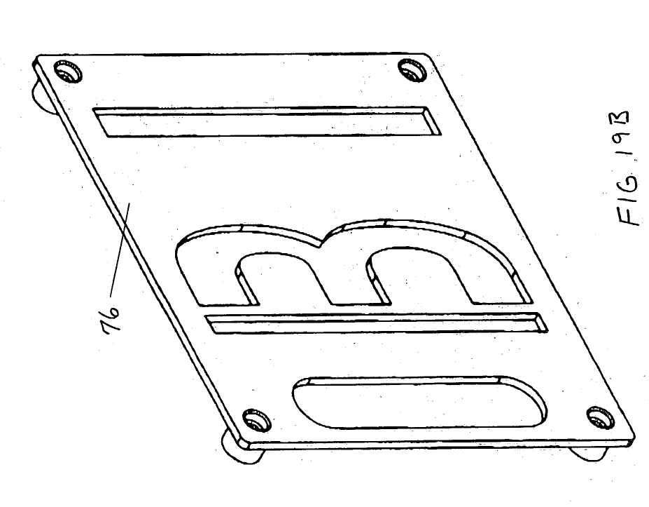

With reference to the drawings, limitations and disadvantages in the art are overcome by the present invention, namely a battery powered illuminating safety device, generally referenced as 10, and depicted in FIGS. 1-19. Safety device 10 comprises a battery powered illuminated signaling device adapted for attachment to a bicycle as depicted in FIGS. 1 and 2, or worn by a jogger at night when adapted with a suitable body harness or belt as depicted in FIGS. 13-16. In a similar manner safety device 10 may be used in connection with a bicycle when adapted with a body harness or belt as depicted in FIG. 17. Interchangeable panels adapted for use with the device to display selected warnings, such as “JOGGER” or “BIKE” are depicted in FIGS. 18A-18B, and 19A-19B. The safety device disclosed herein thus provides a person with a safety device that brightly illuminates the user thereby identifying the user to potential drivers, particularly at night.

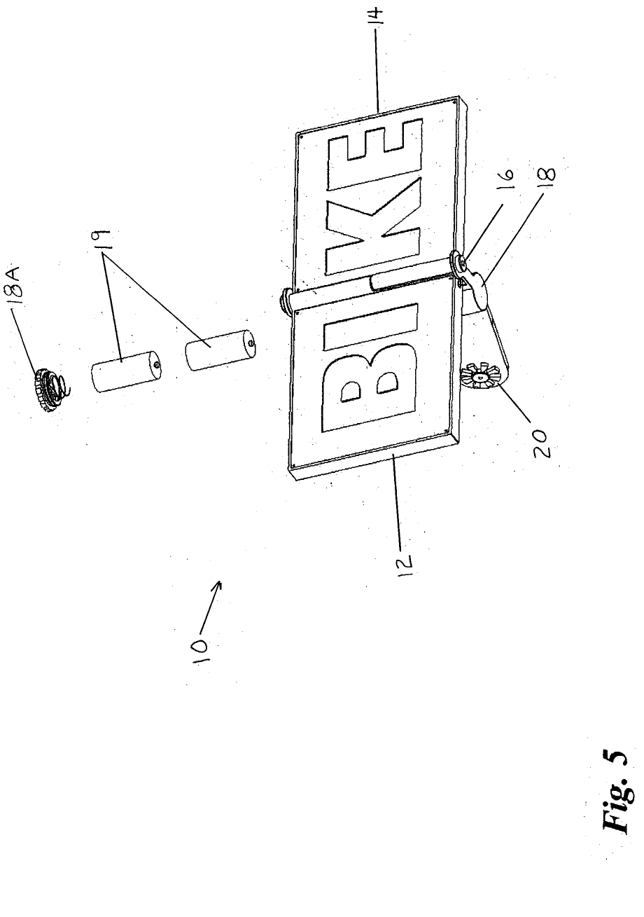

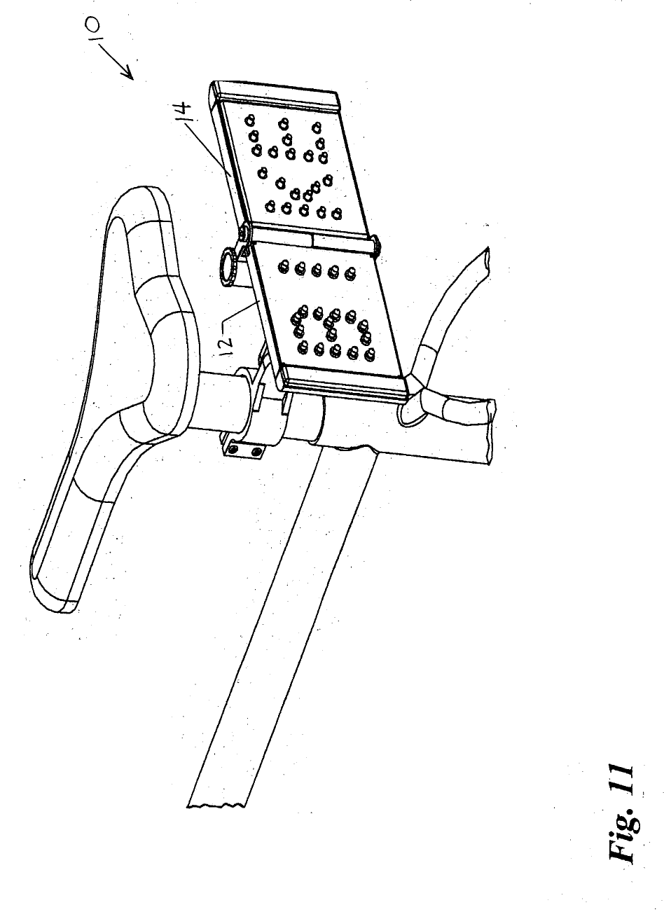

As best depicted in FIGS. 1-7, safety device 10 includes a pair of illuminating left and right panels, referenced as 12 and 14, pivotally connected by a hinge pin assembly 16 disposed between panels 12 and 14. The pivotal connection allows the panels to be configurable between a compact closed configuration wherein the panels are disposed in substantially adjacent overlapping relation as best seen in FIG. 1., to an open configuration wherein the panels form a generally rectangular display as best seen in FIG. 2. Safety device 10 further includes a battery storage compartment 18 having a removable cap 18A for containing one or more batteries. Battery compartment 18 comprises a cylindrical housing adapted for receiving one or more battery power cells, generally referenced as 19, for providing power to the light emitting devices as more fully described herein. In an alternate embodiment, a plurality of battery housings may be incorporated in each of panels 12 and 14 to maximize the power available thereby extending the operational life of the device between battery changes. In an embodiment adapted for direct connection to a bicycle, safety device 10 further includes a mounting bracket 20. Mounting bracket 20 is preferably adapted for connecting to the bicycle seat post hardware so as to secure safety device 10 to the bicycle as depicted in FIG. 11. Panels 12 and 14 further include a signal panel, referenced as 22 and 24, adapted for displaying a message, signal, or wording. As illustrated in FIGS. 5 and 13, the signal panels may be configured to display wording such as “BIKE” or “JOGGER”, or any other suitable wording or signal. FIGS. 18A and 18B depict signal panels 70 and 72 adapted for mounting on illuminating panels 12 and 14 to display the word “JOGGER”. FIGS. 19A and 19B depict signal panels 74 and 76 adapted for mounting on illuminating panels 12 and 14 to display the word “BIKE”.

Safety device 10 preferably further includes light emitting devices 30, such as LED'S or lamps, connected to the battery power source 19 by electrical conductors 32 to provide an illuminated signal. A significant aspect of the present invention involves activating and deactivating the light emitting devices by manual configuration of safety device 10 from the closed to open configurations. More particularly, electrical operation of light emitting devices 20 is controlled by the configuration of panels 12 and 14. When panels 12 and 14 are in the closed configuration depicted in FIG. 1, electrical communication between the battery power source 19 and the light emitting devices 30 is disconnected. Conversely, when panels 12 and 14 are in the open configuration depicted in FIG. 2, electrical communication between the battery power source 19 and the light emitting devices is connected. Accordingly, power is conserved when safety device 10 is in the closed configuration, and is only consumed when safety device 10 is in the open configuration. In an alternate embodiment, a conventional manual on/off power switch may be used, either as a supplemental on/off control feature to that disclosed herein above or as an alternate on/off control feature. Furthermore, in the stored configuration the display surfaces are protected as the opposing display panels are pivotally folded in overlapping face-to-face relation as depicted in FIG. 2.

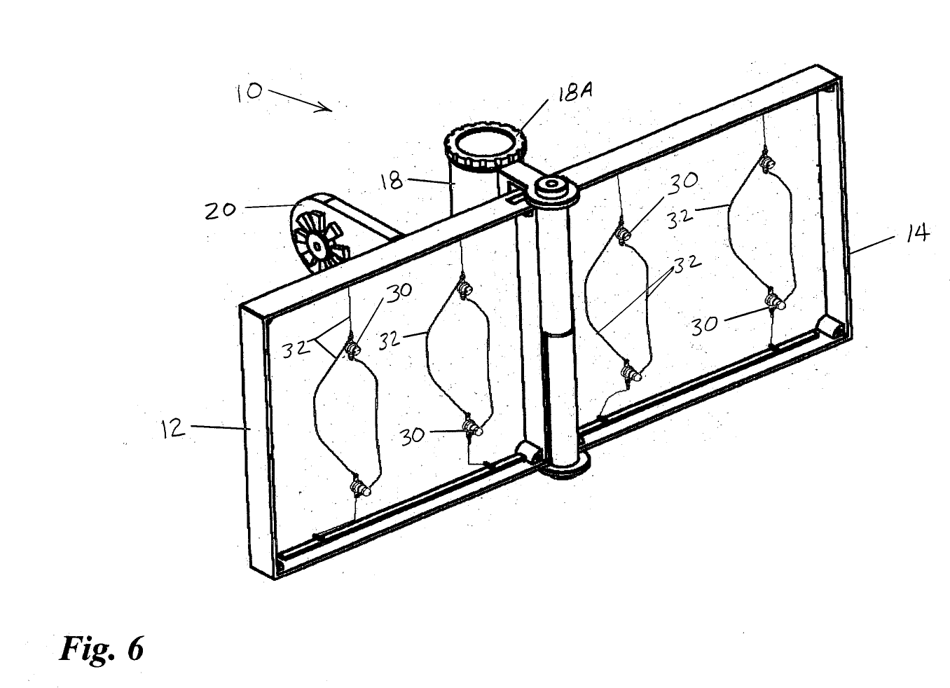

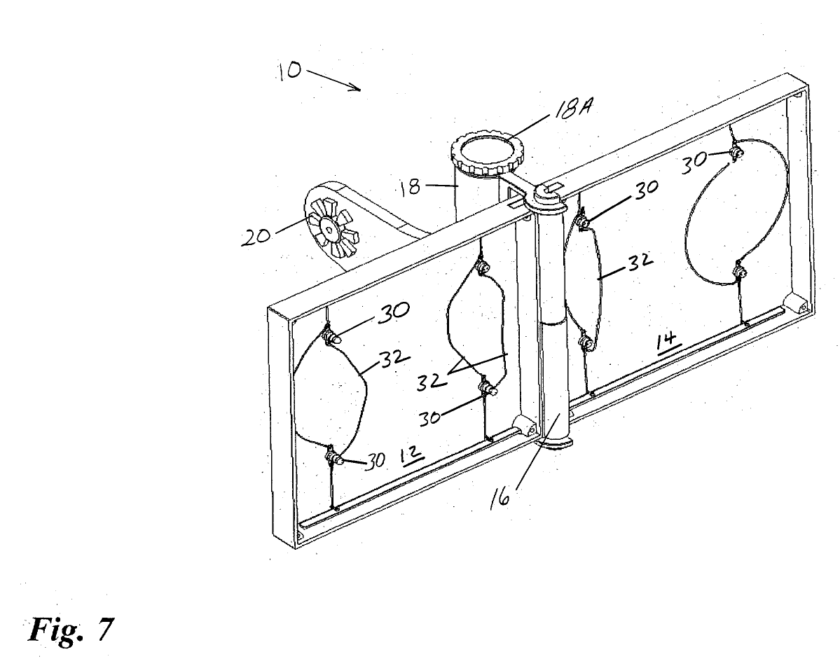

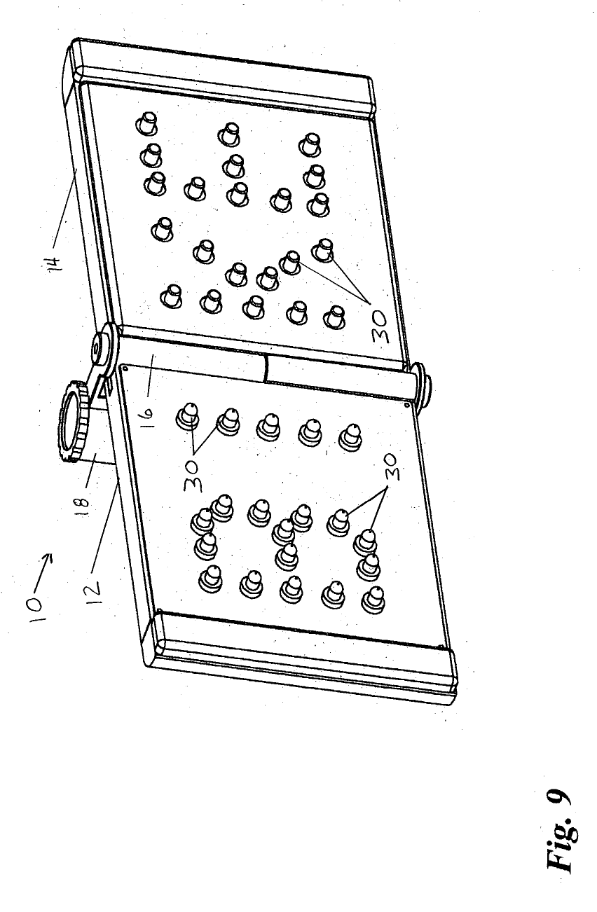

In a first embodiment depicted in FIGS. 6 and 7, light emitting devices 30 may be contained within panels 12 and 14 so as to provide backlighting for signal panels 22 and 24 thereby illuminating the display wording, warning signals, or any other suitable indicia. As disclosed herein above, light emitting devices 30 illuminate only when panels 12 and 14 are configured to the open configuration. In another embodiment shown in FIG. 9-11, a plurality of LED'S 30 are configured into letters that combine to spell “BIKE”, or any other suitable word(s) or signal.

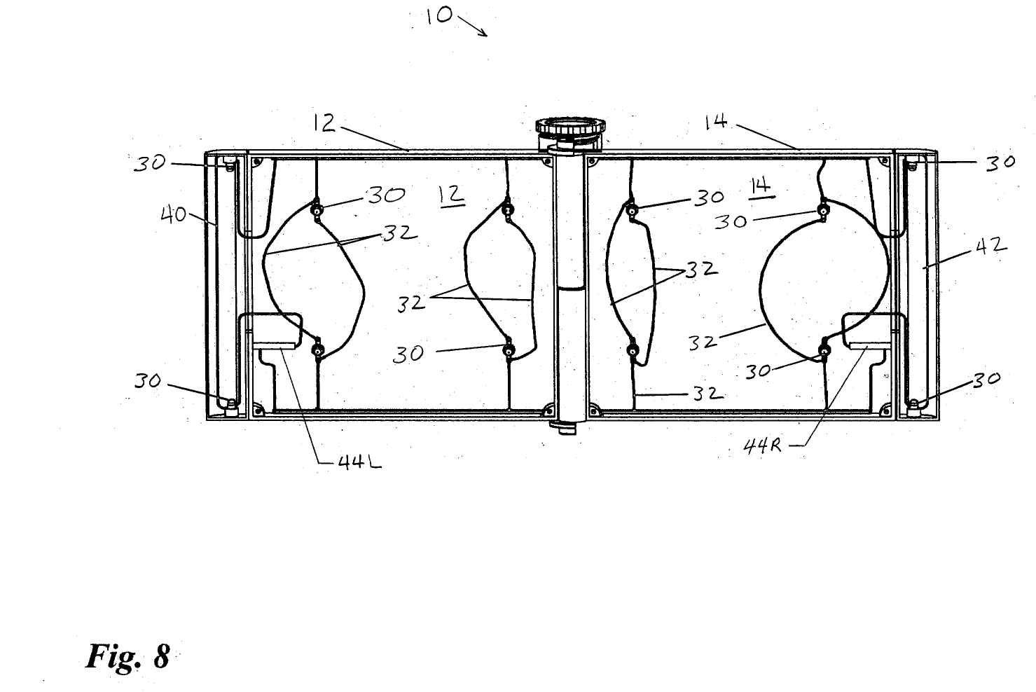

In a second embodiment depicted in FIG. 8, panels 12 and 14 may further incorporate distal end portions, referenced as 40 and 42, configured with LED'S or lamps 30, which function as illuminated turn signals. Specifically, panels 12 and 14 are each adapted with additional electronic circuitry, including conductors 32 configured to selectively illuminate the end portion thereof for providing an illuminated turn signal. The turn signals are automatically activated by means of first and second normally open electromechanical tilt switches, referenced 44L and 44R. More particularly, tilt switch 44L activates, thereby placing the light emitting devices in distal end 40 in electrical communication with battery power source 19, when safety device 10 is tilted to the left, as happens when the user leans into a left hand turn. Similarly, tilt switch 44R activates, thereby placing the light emitting devices in distal end 42 in electrical communication with battery power source 19, when safety device 10 is tilted to the right, as happens when the user leans into a right hand turn. Accordingly, when the biker or jogger leans to turn left or right, the corresponding left or right blinker is activated. Tilt switches 44L or 44R remain in the normally open configuration when safety device 10 is disposed in a generally horizontal position.

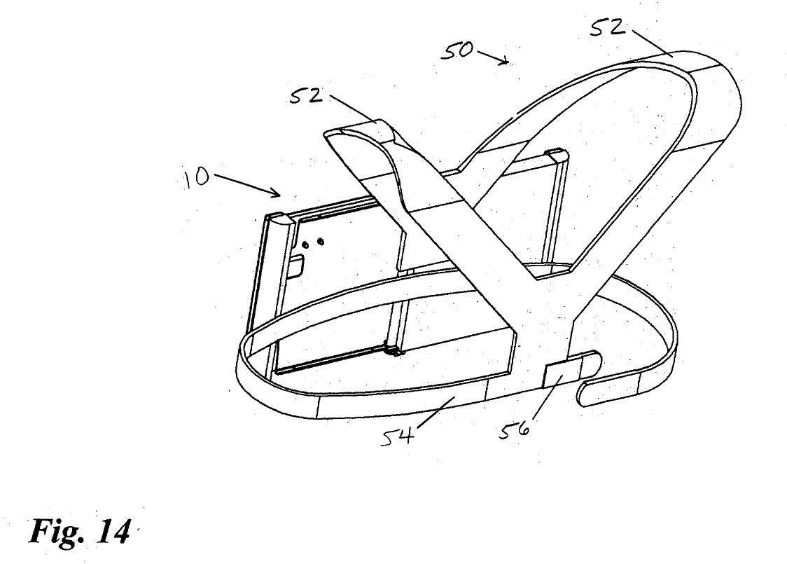

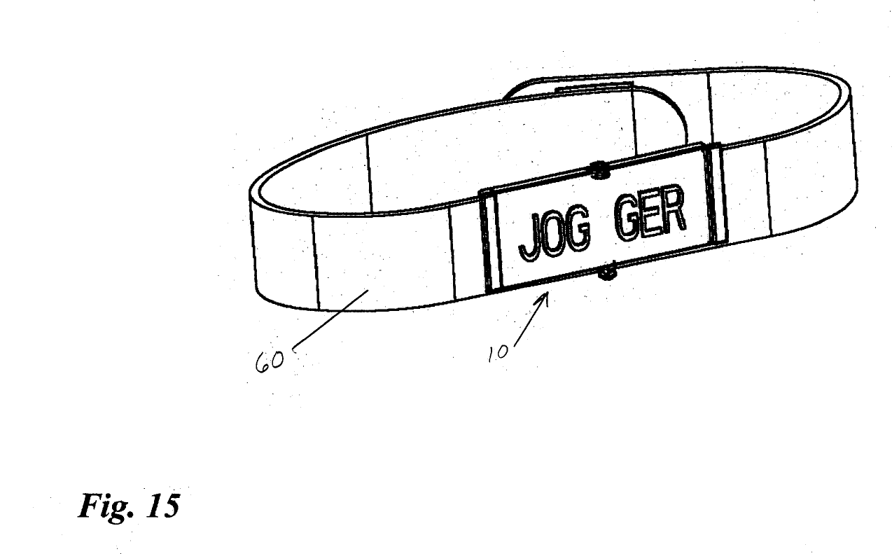

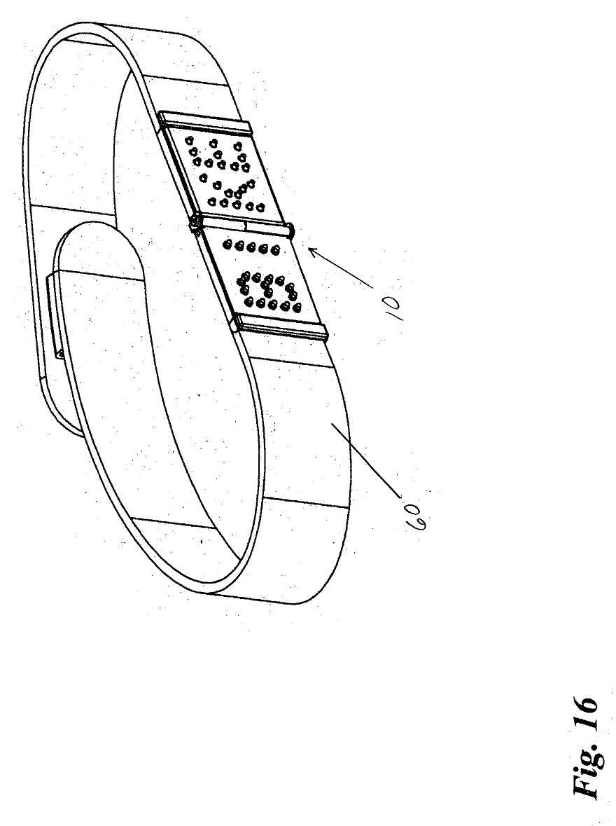

FIGS. 13-17 depict various body harness and belt embodiments wherein safety device 10 may be adapted to be worn on the user's body. FIGS. 13 and 14 depict safety device 10 in an open configuration connected to a body harness 50. Body harness 50 includes shoulder straps 52 and a waist belt 54 for securing safety device 10 to the user's body thereby allowing the user to wear the device while jogging. Waist belt 54 may be adapted with hook and loop fastening material 56 to facilitate secured connection of the belt around the waist of the user. FIGS. 15 and 16 depict an alternate embodiment wherein safety device 10 is connected to a belt 60.

The instant invention has been shown and described herein in what is considered to be the most practical and preferred embodiment. It is recognized, however, that departures may be made therefrom within the scope of the invention and that obvious modifications will occur to a person skilled in the art.

1. An illuminated personal safety device comprising:
first and second panels, each of said panels including at least one light emitting device;
a battery power source electrically connected to said light emitting devices;
said first and second panels being pivotally connected and configurable between a closed configuration wherein said panels are disposed in face to face relation, and an open configuration wherein said panels are disposed in a generally planar side by side relation;
means for electrically connecting said light emitting devices to said battery power source when said panels are configured in the open configuration and for electrically disconnecting said light emitting devices from said battery power source when said panels are configured in the closed configuration.

2. An illuminated personal safety device according to claim 1, wherein said means for electrically connecting said light emitting devices to said battery power source includes at least one set of electrical contacts, said electrical contacts disposed in mating engagement when said panels are configured in the open configuration- and disposed in spaced relation when said panels are configured in the closed configuration.

3. An illuminated personal safety device according to claim 1, further including means for mounting said device to a bicycle.

4. An illuminated personal safety device according to claim 1, further including means for mounting said device to a person.

5. An illuminated personal safety device according to claim 1, wherein said first and second panels include end portions, each end portion including at least one light emitting device adapted to function as a turn signal, and means for selectively activating one of said turn signals in response to the angular position of said safety device.

6. An illuminated personal safety device comprising:
first and second panels, each of said panels including at least one light emitting device;
a battery power source electrically connected to said light emitting devices;
said first and second panels being pivotally connected and configurable between a closed configuration wherein said panels are disposed in face to face relation, and an open configuration wherein said panels are disposed in a generally planar side by side relation;
means for electrically connecting said light emitting devices to said battery power source when said panels are configured in the open configuration and for electrically disconnecting said light emitting devices from said battery power source when said panels are configured in the closed configuration;
said first and second panels further including illuminated turn signals and means for selectively activating said turn signals in response to the angular position of said device.

7. An illuminated personal safety device according to claim 6, wherein said means for selectively activating said turn signals includes at least one normally open tilt switch.

8. An illuminated personal safety device according to claim 6, wherein said first and second panels further include means for displaying illuminated indicia.

9. An illuminated personal safety device according to claim 8, wherein said means for displaying illuminated indicia includes a translucent panel.

10. An illuminated personal safety device according to claim 8, wherein said means for displaying illuminated indicia includes a plurality of light emitting devices arranged to collectively form said indicia when illuminated.

11. An illuminated personal safety device according to claim 6, further including means for mounting said device to a bicycle.

12. An illuminated personal safety device according to claim 6, further including means for mounting said device to a person.

13. An illuminated personal safety device comprising:
first and second pivotally connected panels, each of said panels including a face portion having a primary light emitting device;
said first and second panels each including a distal end, each distal end including a secondary light emitting device;
a battery power source electrically connected to said primary and secondary light emitting devices;
said first and second panels pivotally configurable between a closed configuration wherein said panels are disposed in face to face relation, and an open configuration wherein said panels are disposed in a generally planar side by side relation;
means for selectively electrically connecting said light emitting devices to said battery power source, whereby said primary light emitting devices are illuminated when said panels are configured in the open configuration, and not illuminated when panels are configured in the closed configuration;
first and second normally open tilt switches for selectively electrically connecting said secondary light emitting devices to said battery power source when said panels are configured in the open configuration and said device is angularly disposed relative to horizontal;
said first tilt switch configured to illuminate said secondary light emitting device on said distal end of said first panel when said device is angularly disposed such that said first panel distal end is vertically lower than said second panel distal end;
said second tilt switch configured to illuminate said secondary light emitting device on said distal end of said second panel when said device is angularly disposed such that said second panel distal end is vertically lower than said first panel distal end.

14. An illuminated personal safety device according to claim 13, further including means for mounting said device to a bicycle.

15. An illuminated personal safety device according to claim 13, further including a belt for mounting said device to a person.

16. An illuminated personal safety device according to claim 13, wherein said secondary light emitting devices blink while illuminated.
